(19) United States
(12) Patent Application Publication
(10) Pub. No.: US 2007/0176878 A1
(43) Pub. Date: Aug. 2, 2007

(54) LIQUID CRYSTAL DISPLAY DEVICE AND DRIVING METHOD THEREOF

(75) Inventor: Seung Woo Lee, Seoul (KR)

Correspondence Address: CANTOR COLBURN, LLP, 55 GRIFFIN ROAD SOUTH, BLOOMFIELD, CT, 06002, US

(73) Assignee: SAMSUNG ELECTRONICS CO., LTD, Suwon-si (KR)

(21) Appl. No.: 11/627,455

(22) Filed: Jan. 26, 2007

(30) Foreign Application Priority Data
Jan. 27, 2006 (KR) 10-2006-0008921

(51) Int. Cl. G09G 3/36

(52) U.S. Cl. 345/98

(57) ABSTRACT

A liquid crystal display (“LCD”) device and a driving method thereof, include input data that is converted into first and second data, and one of the first and second data is selectively generated. The first and second data exist together in each field according to a location of a subpixel to prevent a motion blur phenomenon without deteriorating luminance.

This application claims priority to Korean Patent Application No. 2006-0008921, filed on Jan. 27, 2006, and all the benefits accruing therefrom under 35 U.S.C. §119, and the contents of which in its entirety are herein incorporated by reference.

### BACKGROUND OF THE INVENTION

1. Field of the Invention

The present invention relates to a liquid crystal display (“LCD”) device, and more particularly, to an LCD device capable of preventing a motion blur phenomenon without deteriorating luminance, and a driving method thereof.

2. Description of the Related Art

An LCD device includes an image display unit for displaying an image by using electro-optical properties of liquid crystals, a driving circuit for driving the image display unit and a backlight unit for supplying light to the image display unit.

The image display unit displays an image using a plurality of pixels arranged in a matrix. Each pixel includes a combination of red, green and blue subpixels. Each subpixel is represented by a liquid crystal capacitor consisting of a pixel electrode and a common electrode supplying a voltage to a liquid crystal layer. The liquid crystal capacitor is independently driven by a thin film transistor (“TFT”) connected to the gate and data lines.

The LCD device is suitable for displaying a motion picture because it is an active matrix type capable of independently driving each subpixel using the TFT. However, due to a slow response speed caused by the unique viscosity and elasticity of liquid crystals and to a hold type driving characteristic, a motion blur phenomenon occurs by a residual image of a previous frame during playback, thereby deteriorating picture quality.

To solve such a problem, a driving method for preventing the motion blur phenomenon has been proposed that eliminates the residual image of the previous frame by an impulsive driving method that inserts a black frame consisting of black data between frames. However, the impulsive driving method has a shortcoming of deteriorating luminance caused by the insertion of the black frame.

### BRIEF SUMMARY OF THE INVENTION

It is therefore an aspect of the present invention to provide an LCD device capable of preventing a motion blur phenomenon without deteriorating luminance, and a driving method thereof.

In accordance with an exemplary embodiment of the present invention, a method of driving an LCD device includes converting input data into first and second data, selectively generating one of the first and second data, and repeating operations of converting and selectively generating data so that the first and second data exist together in each field according to a location of a subpixel.

The first and second data in each field exist alternately with each other in at least one horizontal line unit, in at least one vertical line unit, in at least one subpixel unit, or in a subpixel block unit consisting of a plurality of subpixels. The selectively generating one of the first and second data may use at least one of horizontal line location information and subpixel location information. The location of a subpixel in which the first and second data exist in each field is opposite to that in an adjacent field. The selectively generating one of the first and second data may further use field information.

The input data is converted into first data of a high gray scale and second data of a low gray scale. The first and second data are uniformly mixed in each field.

In accordance with anther exemplary embodiment of the present invention, an LCD device includes a data converter for converting input data into first and second data and selectively generating one of the first and second data, and a liquid crystal panel for displaying a field in which the first and second data generated from the data converter are mixed according to a location of a subpixel.

The data converter includes a memory for storing the input data, a first look-up table for converting the input data received from the memory into the first data, a second look-up table for converting the input data received from the memory into the second data, and a selector for selectively generating one of the first and second data received from the first and second look-up tables.

The liquid crystal panel displays a field in which the first and second data alternately exist with each other in at least one horizontal line unit, in at least one vertical line unit, in at least one subpixel unit, or in a subpixel block unit consisting of a plurality of subpixels. The selector uses at least one of horizontal line location information and subpixel location information in selectively generating the first and second data. The liquid crystal panel further displays a field in which a location of a subpixel where the first and second data exist is opposite to a previous field. The selector additionally may use field information in selectively generating the first and second data.

The first look-up table converts the input data into first data of a high gray scale and the second look-up table converts the input data into second data of a low gray scale. The liquid crystal panel displays a field in which the first and second data are uniformly mixed.

### BRIEF DESCRIPTION OF THE DRAWINGS

The above and other aspects, features and advantages of the present invention will become more apparent from the following detailed description when taken in conjunction with the accompanying drawings in which:

FIG. 1 is a block diagram illustrating an LCD device according to an exemplary embodiment of the present invention;

FIG. 2 is a waveform chart illustrating data supplied to one subpixel of an LCD panel illustrated in FIG. 1;

FIG. 3 is a detailed block diagram illustrating a data converter illustrated in FIG. 1;

FIG. 4 is a diagram illustrating a data structure of first and second fields for describing a general data processing method;

FIG. 5 is a diagram illustrating a data structure of first and second fields for describing a data processing method according to a first exemplary embodiment of the present invention;

FIG. 6 is a diagram illustrating a data structure of first and second fields for describing a data processing method according to a second exemplary embodiment of the present invention;

FIG. 7 is a diagram illustrating a data structure of first and second fields for describing a data processing method according to a third exemplary embodiment of the present invention;

FIG. 8 is a diagram illustrating a data structure of first and second fields for describing a data processing method according to a fourth exemplary embodiment of the present invention; and

FIG. 9 is a diagram illustrating a data structure of first and second fields for describing a data processing method according to a fifth exemplary embodiment of the present invention.

### DETAILED DESCRIPTION OF THE INVENTION

The invention will now be described more fully hereinafter with reference to the accompanying drawings, in which exemplary embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present there between. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

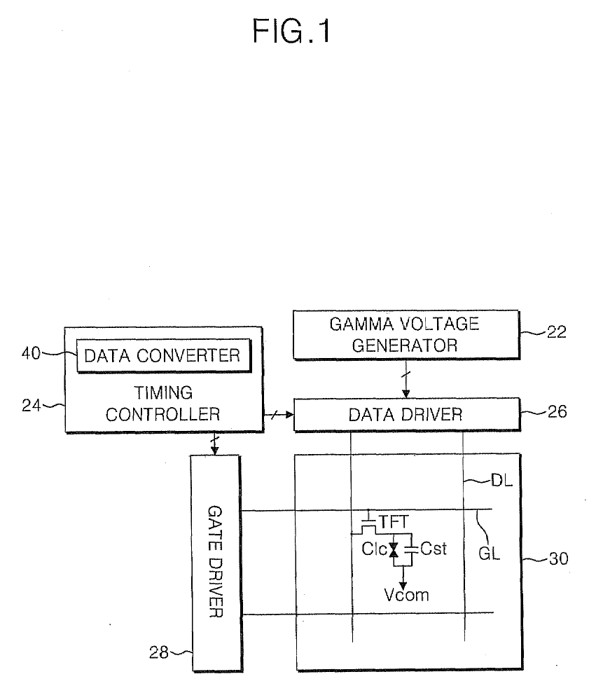

The exemplary embodiments of the present invention will now be described with reference to FIGS. 1 to 9.

FIG. 1 is a block diagram of an LCD device according to an exemplary embodiment of the present invention

The LCD device illustrated in FIG. 1 includes a gate driver 28 for driving gate lines GL of an LCD panel 30, a data driver 26 for driving data lines DL of the LCD panel 30, a gamma voltage generator 22 for generating a gamma voltage and supplying the gamma voltage to the data driver 26, and a timing controller 24 for controlling the data and gate drivers 26 and 28, splitting input data into first and second data and supplying the first and second data to the data driver 26.

The timing controller 24 splits input data received from an external computer system (not shown) into first and second data through a data converter 40 and supplies the first and second data to the data driver 26. Namely, the data converter 40 converts the input data into the first data of a high gray scale and the second data of a low gray scale at a speed of twice an input frequency to the data converter 40 by using a look-up table. Thereafter, the data converter 40 selects the first and second data from different fields and supplies the first and second data to the data driver 26. The data converter 40 selectively supplies the first and second data to the data driver 26 by using line information of each subpixel or the line information and pixel information so that both the first and second data exist together in each field. This is because a flicker phenomenon may occur due to a data difference between fields if each field consists of either only the first data or only the second data. The data converter 40 will be described later on. The timing controller 24 generates a plurality of control signals for controlling the driving timing of the gate and data drivers 28 and 26 by using a plurality of control signals received from the external computer system together with data, for example, by using a dot clock, a data enable signal, a vertical synchronization signal, a horizontal synchronization signal, etc.

The gamma voltage generator 22 generates a plurality of gamma voltages depending on a plurality of gray scales by dividing a gamma driving voltage received from a power supply and supplies the plurality of gamma voltages to the data driver 26.

The data driver 26 converts digital data received from the timing controller 24 into an analog data signal and supplies the analog data signal to a plurality of data lines DL of the LCD panel 30. The data driver 26 selects a gamma voltage of a gray scale corresponding to the digital data received from the timing controller 24 among the plurality of gamma voltages generated from the gamma voltage generator 22 and supplies the selected gamma voltage to each data line of the LCD panel 30. At this time, the data driver 26 selects a gamma voltage of positive polarity or negative polarity (e.g., relative to a common voltage reference) according to a polarity control signal received from the timing controller 24 and supplies the selected gamma voltage to each data line.

The gate driver 28 generates a gate signal according to a control signal from the timing controller 24 and sequentially drives a plurality of gate lines GL. The gate driver 28 sequentially supplies a gate ON voltage to the plurality of gate lines GL according to the control signal from the timing controller 24 and supplies a gate OFF voltage until the gate ON voltage is supplied in the next field.

The LCD panel 30 displays an image using a combination of pixels arrayed in a matrix. Each of the pixels includes a combination of red, green and blue subpixels. Each subpixel is represented by a liquid crystal capacitor Clc consisting of a pixel electrode and a common electrode supplying a voltage to a liquid crystal layer. The liquid crystal capacitor Clc is independently driven by a TFT connected to the gate and data lines GL and DL. The TFT is turned on by the gate ON voltage of the gate line GL to charge a data signal of the data line DL to the liquid crystal capacitor Clc. The TFT is turned off by the gate OFF voltage of the gate line GL to maintain the data signal charged to the liquid crystal capacitor Clc. The liquid crystal capacitor Clc drives liquid crystals by charging the data signal supplied through the TFT on the basis of a common voltage Vcom supplied to the common electrode, thereby adjusting transmittance of light from each subpixel. Each subpixel includes a storage capacitor Cst connected in parallel to the liquid crystal capacitor Clc to compensate for a leakage current while the TFT is turned off. Each subpixel of the LCD panel 30 accomplishes a corresponding gray scale by a combination of the first and second data supplied separately in two fields through the data driver 26.

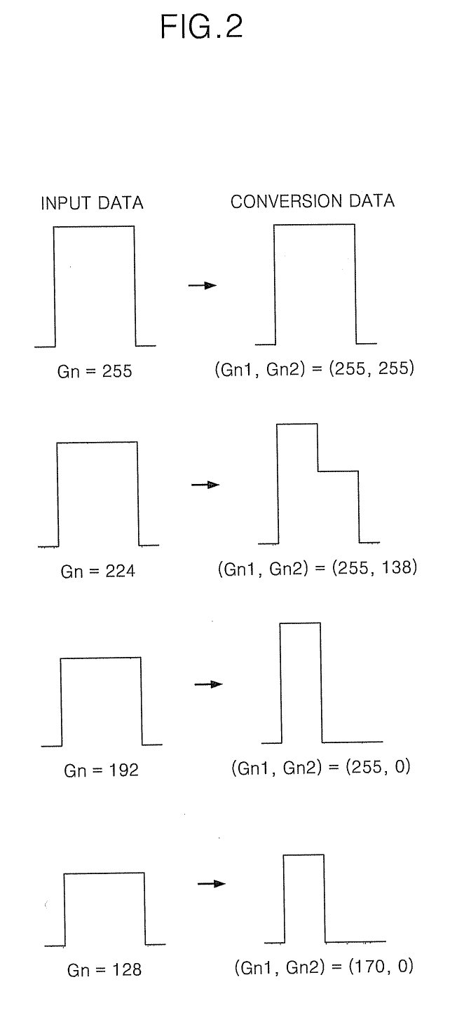

As illustrated in FIG. 2 for example, a gray scale value of 128 as input data Gn corresponds to one subpixel represented by a combination of gray scale values of 170 and 0 of first and second data Gn1 and Gn2, respectively; a gray scale value of 192 as input data Gn corresponds to gray scale values of 255 and 0 of first and second data Gn1 and Gn2, respectively; a gray scale value 224 as input data Gn corresponds to gray scale values of 255 and 138 of first and second data Gn1 and Gn2, respectively; and a gray scale value of 255 as input data Gn corresponds to gray scale values of 255 and 255 of first and second data Gn1 and Gn2, respectively. The first and second data Gn1 and Gn2 are respectively supplied to one subpixel in each of different adjacent fields, that is, an odd field and an even field and at this time the supplying order of the first and second data Gn1 and Gn2 supplied to the one subpixel is not limited. Thus, by alternately supplying the first data Gn1 of a high gray scale and the second data Gn2 of a low gray scale to each subpixel of the LCD panel 30, each subpixel is driven like an impulsive driving method by a voltage difference between the first and second data Gn1 and Gn2, thereby preventing a motion blur phenomenon. Since both the first data Gn1 and the second data Gn2 exist together in respective fields constituting the entire screen of the LCD panel 30, a flicker caused by a difference between the first and second data Gn1 and Gn2 is prevented.

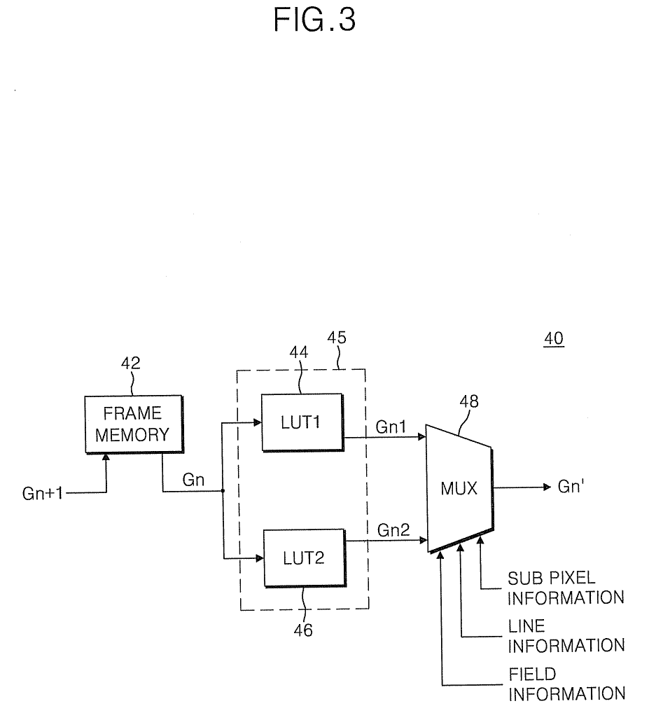

FIG. 3 is a detailed block diagram of the data converter 40 illustrated in FIG. 1.

Referring to FIG. 3, the data converter 40 includes a frame memory 42 for storing input data Gn+1 on a frame basis, a look-up table (“LUT”) 45 for splitting data Gn received from the frame memory 42 into the first and second data Gn1 and Gn2, respectively, and a multiplexer (“MUX”) 48 for selectively generating the first and second data Gn1 and Gn2 generated from the LUT 45.

The frame memory 42 stores the data Gn+1 received from the exterior on a frame basis and supplies the stored data Gn to the LUT 45. In this case, the frame memory 42 supplies the data Gn stored at a speed of twice an input frequency of the external data Gn+1 to the LUT 45.

The LUT 45 splits the data Gn input from the frame memory 42 twice as fast into the first and second data Gn1 and Gn2 and correspondingly generates the first and second data Gn1 and Gn2 twice as fast. The LUT 45 includes a first LUT (“LUT1”) 44 for converting the data Gn input from the frame memory 42 twice as fast into the first data Gn of a high gray scale and a second LUT (“LUT2”) 46 for converting the data Gn input from the frame memory 42 twice as fast into the second data Gn of a low gray scale. The LUT1 44 stores the first data Gn1 of the high gray scale depending on gray levels of the data Gn and selectively generates the first data Gn1 of the high gray scale corresponding to the data Gn received from the frame memory 42 among the stored first data Gn1. The LUT2 46 stores the second data Gn2 of the low gray scale depending on the gray values of the data Gn and selectively generates the second data Gn2 of the low gray scale corresponding to the data Gn received from the frame memory 42 among the stored second data Gn2.

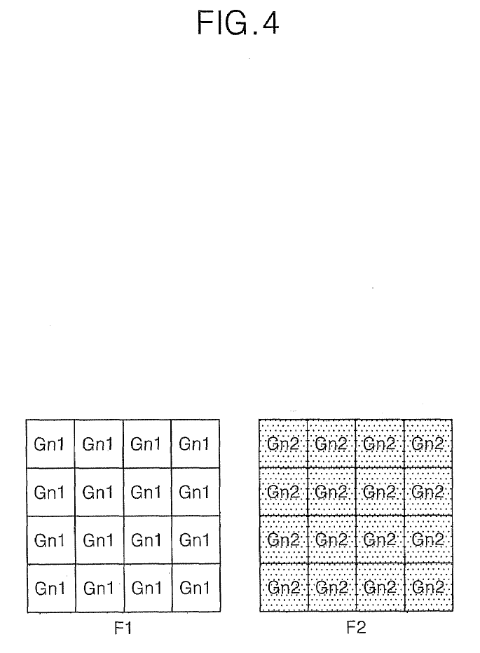

The MUX 48 selectively supplies the first and second data Gn1 and Gn2 generated from the LUT1 44 and LUT2 46, respectively, to the data driver 26. The LUT1 44 and LUT2 46 repeat an operation of converting the input data Gn from the frame memory 42 into the first and second data Gn1 and Gn2, respectively, and the MUX 48 repeats an operation of selectively generating one of the first and second data Gn1 and Gn2 from the LUT1 and LUT2. The selective operation of the MUX 48 is controlled such that the first and second data Gn1 and Gn2 are uniformly mixed in the respective fields. If an odd field F1 consists of only the first data Gn1 and an even field F2 consists of only the second data Gn2 as illustrated in FIG. 4, a flicker may be generated due to a voltage difference between the odd field F1 consisting of only the first data Gn1 and the even field F2 consisting of only the second data Gn2.

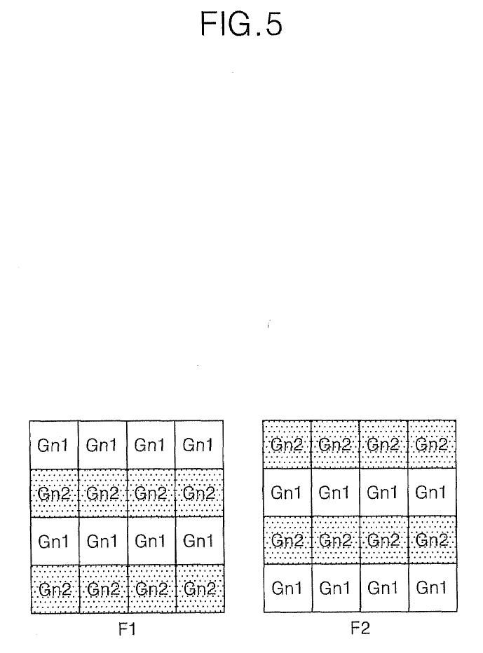

In order to prevent such a flicker, the MUX 48 uses line information indicating a location of a horizontal line as a control signal together with field information. The field information is generated by counting a vertical synchronization signal. The line information is generated by counting a horizontal synchronization signal, or a data enable signal indicating effective data during each horizontal synchronization period. The MUX 48 controls the first and second data Gn1 and Gn2 by using the horizontal line information as shown in FIG. 5 to alternate with each other in at least one horizontal line unit (e.g., alternate in at least each row) in each field. Furthermore, the MUX 48 causes a horizontal line to which the first data Gn1 is supplied and that to which the second data Gn2 is supplied to be opposite to each other in the odd field F1 and the even field F2, respectively, by the field information.

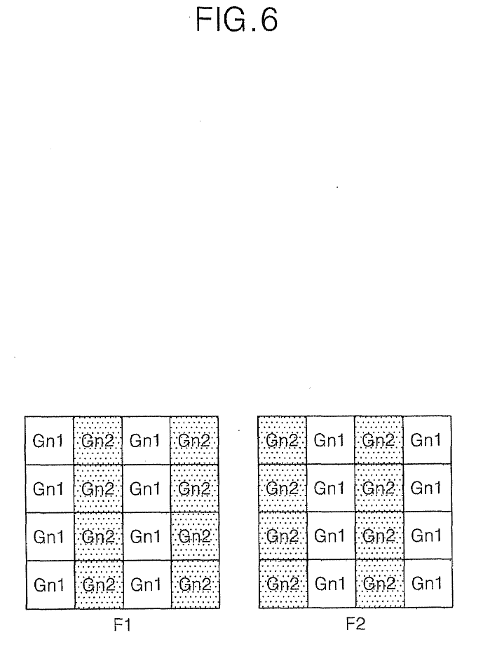

Alternatively referring to FIG. 6, the MUX 48 uses subpixel location information indicating a location of a subpixel as the control signal together with the field information and the horizontal line information. The subpixel location information is generated, for example, by counting a dot clock transmitting subpixel data. The MUX 48 controls the first and second data Gn1 and Gn2 by using the subpixel location information and the horizontal line information to alternate with each other in at least one vertical line unit (e.g., alternate in at least each column) in each field. Moreover, the MUX 48 causes a vertical line to which the first data Gn1 is supplied and that to which the second data Gn2 is supplied to be opposite to each other in the odd field F1 and the even field F2, respectively, by the field information.

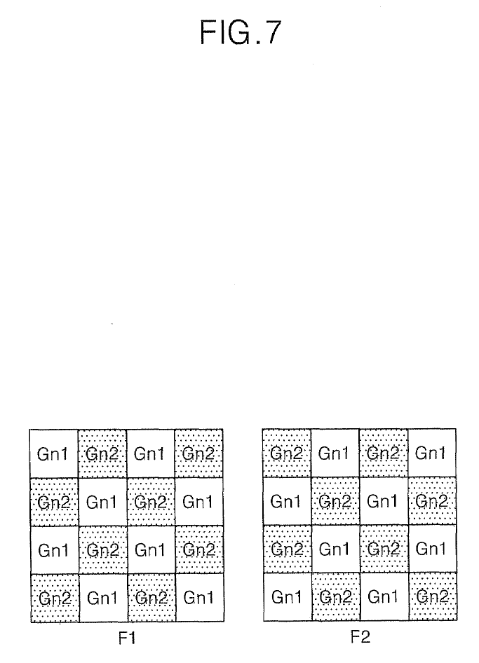

As another data processing method referring to FIG. 7, the MUX 48 controls the first and second data Gn1 and Gn2 by the subpixel location information and horizontal line information to alternate with each other in a subpixel unit in a horizontal direction and in a horizontal line unit in a vertical direction in each field. Moreover, the MUX 48 causes the first and second data Gn1 and Gn2 to alternate with each other in a subpixel unit in an opposite way in the odd field F1 and the even field F2, respectively, by the field information.

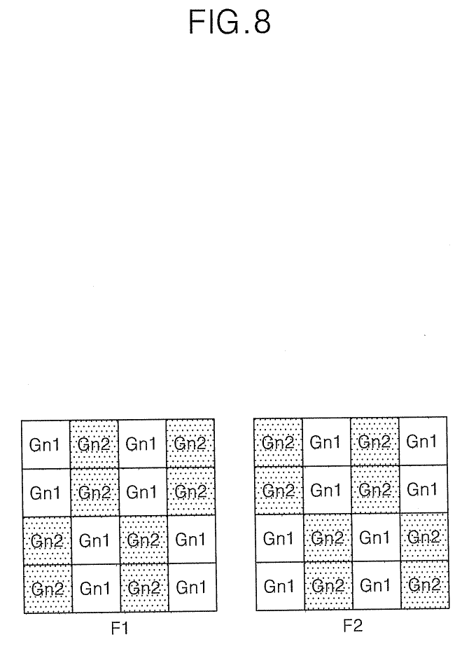

As still another data processing method referring to FIG. 8, the MUX 48 controls the first and second data Gn1 and Gn2 in each field by the subpixel location information and the horizontal line information to alternate with each other in a subpixel unit in a horizontal direction and in a unit of a plurality of horizontal lines, two horizontal lines for example, in a vertical direction. Further, the MUX 48 controls the first and second data Gn1 and Gn2 by the field information to alternate with each other in a subpixel unit and in a unit of a plurality of horizontal lines in an opposite way in the odd field F1 and the even field F2, respectively.

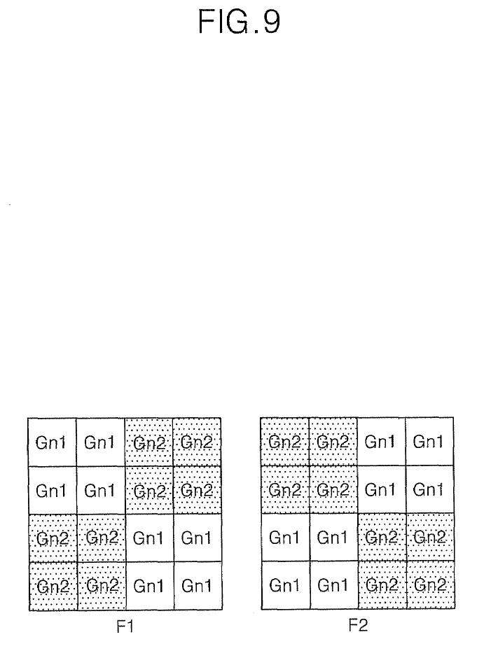

As still another data processing method referring to FIG. 9, the MUX 48 controls the first and second data Gn1 and Gn2 in each field by the subpixel location information and the horizontal line information to alternate with each other in a subpixel block unit consisting of a plurality of subpixels. Further, the MUX 48 controls the first and second data Gn1 and Gn2 by the field information to alternate with each other in a subpixel block unit in an opposite way in the odd field F1 and the even field F2, respectively.

As described above, in the LCD device and driving method thereof according to the present invention, data is split into first and second data to prevent a motion blur phenomenon and the first and second data exist together in each field. Therefore, picture degradation such as a flicker due to a difference between the first and second data can be prevented.

While the invention has been shown and described with reference to exemplary embodiments thereof, it will be understood by those skilled in the art that various changes in form and details may be made therein without departing from the spirit and scope of the invention as defined by the appended claims.

What is claimed is:

1. A method of driving a liquid crystal display device, the method comprising:
converting input data into first and second data;
selectively generating one of the first and second data; and
repeating operations of the converting input data and the selectively generating one of the first and second data so that the first and second data exist together in each field according to a location of a subpixel.

2. The method as defined in claim 1, wherein the first and second data in each field alternately exist with each other in at least one horizontal line unit or in at least one vertical line unit.

3. The method as defined in claim 1, wherein the first and second data in each field alternately exist in at least one subpixel unit.

4. The method as defined in claim 1, wherein the first and second data in each field alternately exist in a subpixel block unit consisting of a plurality of subpixels.

5. The method as defined in claim 1, wherein the selectively generating one of the first and second data uses at least one of horizontal line location information and subpixel location information.

6. The method as defined in claim 5, wherein the location of a subpixel in which the first and second data exist in each field is opposite to that in an adjacent field.

7. The method as defined in claim 6, wherein the selectively generating one of the first and second data further uses field information.

8. The method as defined in claim 6, wherein the input data is converted into the first data of a high gray scale and the second data of a low gray scale.

9. The method as defined in claim 6, wherein the first and second data are uniformly mixed in each field.

10. A liquid crystal display device, comprising:
a data converter which converts input data into first and second data and selectively generates one of the first and second data; and
a liquid crystal panel which displays a field in which the first and second data generated from the data converter are mixed according to a location of a subpixel.

11. The liquid crystal display device as defined in claim 10, wherein the data converter comprises:
a memory which stores the input data;
a first look-up table which converts the input data received from the memory into the first data;
a second look-up table which converts the input data received from the memory into the second data; and
a selector which selectively generates one of the first and second data received from the first and second look-up tables, respectively.

12. The liquid crystal display device as defined in claim 11, wherein the liquid crystal panel displays a field in which the first and second data alternately exist with each other in at least one horizontal line unit or in at least one vertical line unit.

13. The liquid crystal display device as defined in claim 11, wherein the liquid crystal panel displays a field in which the first and second data alternately exist with each other in at least one subpixel unit.

14. The liquid crystal display device as defined in claim 11, wherein the liquid crystal panel displays a field in which the first and second data alternately exist with each other in a subpixel block unit consisting of a plurality of subpixels.

15. The liquid crystal display device as defined in claim 11, wherein the selector uses at least one of horizontal line location information and subpixel location information in selectively generating the first and second data.

16. The liquid crystal display device as defined in claim 15, wherein the liquid crystal panel further displays a field in which a location of a subpixel where the first and second data exist is opposite to a previous field.

17. The liquid crystal display device as defined in claim 16, wherein the selector additionally uses field information in selectively generating the first and second data.

18. The liquid crystal display device as defined in claim 16, wherein the first look-up table converts the input data into the first data of a high gray scale and the second look-up table converts the input data into the second data of a low gray scale.

19. The liquid crystal display device as defined in claim 16, wherein the liquid crystal panel displays a field in which the first and second data are uniformly mixed.
